(19) United States
(12) Patent Application Publication
(10) Pub. No.: US 2001/0005904 A1
(43) Pub. Date: Jun. 28, 2001

(54) Broadcast enhancement system and method

(75) Inventor: Karl J. Wood, Crawley (GB)

Correspondence Address: Michael E. Marion, c/o PHILIPS ELECTRONICS NORTH AMERICA CORPORATION, Corporate Intellectual Property, 580 White Plains Road, Tarrytown, NY, 10591, US

(73) Assignee: U.S. PHILIPS CORPORATION.

(21) Appl. No.: 09/747,109

(22) Filed: Dec. 21, 2000

(30) Foreign Application Priority Data
Dec. 22, 1999 (GB) 9930306.7

(51) Int. Cl. H04N 5/445; G06F 3/00; G06F 13/00

(52) U.S. Cl. 725/51; 348/592; 725/40

(57) ABSTRACT

A broadcast enhancement system and method for enhancing a received television broadcast signal using a received enhancement signal, at least one of which is prepared for chroma keying. The system is configured to intercept the television broadcast signal before it is passed to the television and to apply chroma keying to superimpose the enhancement signal to the television broadcast signal before passing the superimposed signal to the television.

The present invention relates to a broadcast enhancement system and method which allow supplementary information to be superimposed over a broadcast. The present invention is particularly applicable to the enhancement of digital television broadcasts.

When a television broadcast is made, a completed television programme is transmitted in a form so that upon receipt by a television the broadcast merely needs displaying. This is also true for encoded broadcast systems such as OnDigital in which encoded broadcasts are received and decoded by set-top-boxes prior to being displayed. Normally, no processing of the broadcast is performed by the receiver other than decoding for display.

If a broadcast is to consist of more than one source at any one time, for example if a sports broadcast is to include a replay of events in a window in the corner of a main broadcast, such superimposition is performed by the broadcaster prior to transmission. One technique used for superimposing images in video, television broadcasts or films is chroma keying. This technique, also known as blue screen imaging, takes a first visual source captured in front of an evenly lit, bright, pure coloured background (normally blue) and superimposes it over another source such as live video, digital computer images, photographs or movies in such a way that the blue background from the first source is omitted and the subject of the first source appears superimposed over the second source.

The chroma key technique is based on a luminance key. In a luminance key, everything in the image over (or under) a set brightness level is “keyed” out and replaced by another image, or a colour from a colour generator. In chroma keying, when the phase of the chroma signal corresponds to the preprogrammed state or states associated with the background colour, or range of colours, behind the principal subject, the signal from the other source is inserted in the composite signal and presented at the output. When the phase of the chroma signal deviates from that associated with the background colour(s) behind the principal subject, video associated with the principal subject is presented at the output. This technique is particularly well known in the creation of titles, special effects, and television weather broadcasts.

Whilst television studios and film production systems offer the sophisticated equipment necessary to superimpose two data sources, the television and set- top-box equipment owned by the typical man in the street commonly does not. As broadcasts become more sophisticated, it is not always desirable for superimposition to occur at the source of a broadcast. A broadcast may in future cater for different languages, for example by supplying titles in a number of different languages. As another example, a user may be offered a number of different options in a form of interactive television, allowing a user to have a picture from one source shown in a small window in a picture from another source, for example showing TV listings in the corner of a window. As a further example, data from two different sources may be superimposed, for example for football scores, share prices etc. to be displayed in a bar along the bottom of a normal TV broadcast coming from a different source. In these cases, new televisions and set-top-boxes incorporating additional hardware and/or software would have to be developed resulting in consumers having to replace expensive equipment to be able to use such enhancements.

According to one aspect of the present invention, there is provided a broadcast enhancement system for enhancing a received television broadcast signal using a received enhancement signal, at least one of which being prepared for chroma keying, the system being configured to intercept the television broadcast signal before it is passed to the television, to apply chroma keying to superimpose the enhancement signal to the television broadcast signal and to pass the superimposed signal to the television.

The system may include a processor for formatting data received in the enhancement signal prior to applying chroma keying to superimpose it onto the television broadcast signal.

The enhancement signal may preferably comprise a World Wide Web page.

The enhancement signal may be multiplexed with the television broadcast signal prior to transmission, in which case the system may include a demultiplexer for extracting the enhancement signal from the received television broadcast signal.

The enhancement signal is preferably received as teletext. Alternatively, it may be received via the internet.

According to another aspect of the present invention, there is provided a method of enhancing a television broadcast comprising the steps of preparing a plurality of broadcast signals, at least one of which being prepared for chroma keying, transmitting the plurality of broadcast signals to a receiver, the receiver applying chroma keying to the received signals to create a superimposed signal for display as an enhanced television broadcast.

The preparation for chroma keying may comprise masking one or more areas of one of the broadcast signals so that the masked area is not displayed after said chroma keying.

The method may include the step of processing one of said received broadcast signals according to instructions in the broadcast signal to prepare the signal for chroma keying.

An example of the present invention will now be described in detail with reference to the accompanying drawings in which:

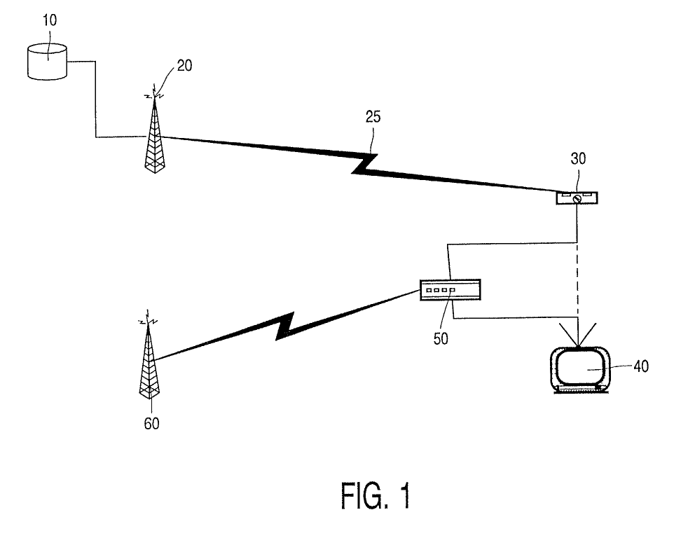

FIG. 1 is a schematic representation of a system embodying the present invention; and,

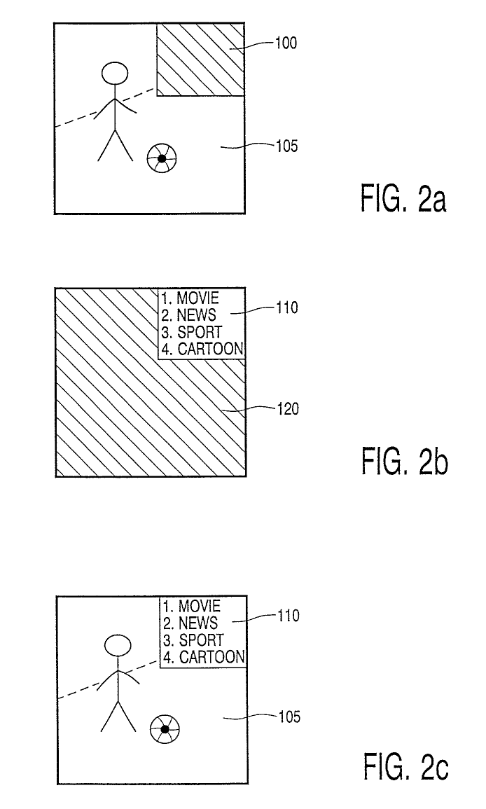

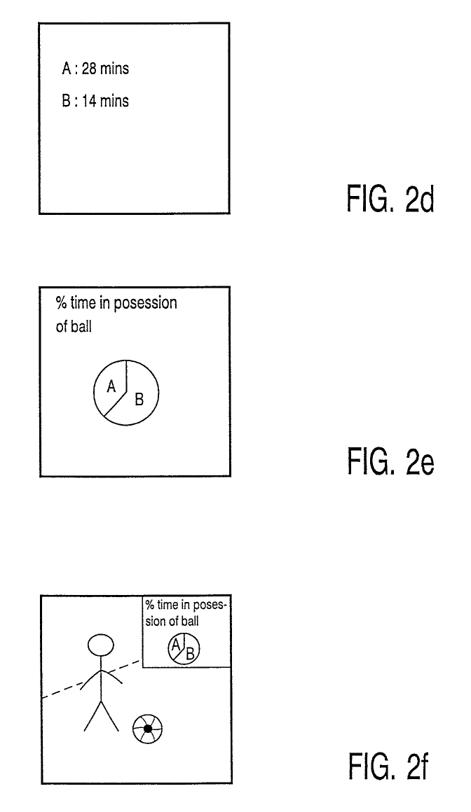

FIG. 2a-f are a number of screen views showing the operation of the present invention.

FIG. 1 is a schematic representation of a system embodying the present invention. A television signal source 10 provides a television programme to be broadcast to a number of recipients. The television programme has been generated such that at certain points throughout the broadcast, masked (normally uniformly blue coloured), areas are available for another source to be superimposed.

The television programme is transmitted by a transmitter 20 over a channel 25 to a number of receiver set-top-boxes 30 connected to a respective television apparatus 40. The channel 25 may be a broadcast channel such as a satellite connection, terrestrial broadcast network or a cable.

The set-top-box 30 decodes the broadcast and passes it as a television signal to the television apparatus 40. Connected in between the set-top-box 30 and the television apparatus 40 is a mixer system 50. The mixer system 50 intercepts television signals passed from the set top box 30 to the television apparatus 40 and superimposes supplementary information received from a source 60 onto the television signal in the masked areas defined by the broadcaster. A signal comprising the television signal with the superimposed information is then passed to the television apparatus 40 for display.

The supplementary information received from source 60 consists of one or more World Wide Web pages. The WWW pages may include text, graphics, audio and even low fidelity video. Areas of the WWW page not to be superimposed over the television signal are filled in a uniform colour, normally blue, which is filtered out during the Chroma keying process. As WWW pages transmitted over the Internet typically suffer from delays, it is preferred that limited real time information display is achieved by broadcasting the WWW data or URL's via teletext. As the supplementary information in this case is received from the same source as the television signal, when the mixer system 50 intercepts the television signals passed from the set-top-box 30 it demultiplexes the two signals to obtain the WWW data to be superimposed over the television signal. Alternatively, the source 60 may be linked to the mixer system 50 via the Internet, another television signal, a local area network or some other telecommunications link.

In the above described embodiment the mixer system 50 serves simply to intercept television signals from the set-top-box, superimpose the supplementary information from source 60 and pass the combined signal to the television apparatus 40. Such a mixer system may be implemented as a further set-top-box without any adaptation required to set-top-box 30 or the television apparatus 40. In a preferred embodiment of the present invention, the mixer system 50 resembles a WebTV which could be integrated into the set-top-box 30, or alternatively it could be a PC equipped with suitable hardware.

The mixer system 50 may include data processing and display software to further enhance the WWW data received. For example, a racing car driver's pulse rate may be supplied via a WWW page which is processed by the mixer system 50 and turned into a bar graph using standard web techniques, such as Java (—Java is a Registered Trademark of Sun Microsystems) to create a bar graph overlay with extensions to read teletext information (which, in this case would be the real time value of the pulse rate) and to drive the bar graph in real time.

FIGS. 2a-f are a number of screen views showing the operation of the present invention. FIG. 2a shows a frame from a television programme signal 105 prepared by a broadcaster including a masked area 100. The broadcast is received by a set-top-box and passed to a mixer system. FIG. 2b shows a WWW page prepared by the broadcaster and transmitted to be received by the mixer system which defines the content 110 to be displayed in the masked area 100 and areas 120 to be filtered out during the chroma keying process. FIG. 2c shows the image combined signals. FIG. 2d shows a WWW page containing real-time data to be displayed. The data is processed by the mixer system to produce a continually updating graph of FIG. 2e which is then chroma keyed into a television signal to give an image shown in FIG. 2f.

Whilst in the above description both signals to be superimposed have defined masked areas, it will be apparent that only one of the signals needs a masked area for the operation of the present invention. For example, a television signal may be transmitted without any masked areas and the supplementary information may be in the form of titles where the background is of the masked colour. In this situation titles can be superimposed over an unmodified broadcast in dependence on the receiver's language or other criteria. For an example mechanism to trigger supplementary information which may not have been transmitted in synchronism with the television signal, the reader's attention is directed to PCT publication WO 98/53611 which is incorporated herein by way of reference material.

1. A broadcast enhancement system for enhancing a received television broadcast signal using a received enhancement signal, at least one of which being prepared for chroma keying, the system being configured to intercept the television broadcast signal before it is passed to the television, to apply chroma keying to superimpose the enhancement signal to the television broadcast signal and to pass the superimposed signal to the television.

2. A system according to claim 1, including a processor for formatting data received in the enhancement signal prior to applying chroma keying to superimpose it onto the television broadcast signal.

3. A system according to claim 1, in which the enhancement signal comprises a World Wide Web page.

4. A system according to claim 1 in which the enhancement signal is multiplexed with the television broadcast signal prior to transmission, wherein the system includes a demultiplexer for extracting the enhancement signal from the received television broadcast signal.

5. A system according to claim 1, in which the enhancement signal is received as teletext.

6. A system according to claim 1, in which the enhancement signal is received via the internet.

7. A method of enhancing a television broadcast comprising the steps of preparing a plurality of broadcast signals, at least one of which being prepared for chroma keying, transmitting the plurality of broadcast signals to a receiver, the receiver applying chroma keying to the received signals to create a superimposed signal for display as an enhanced television broadcast.

8. A method according to claim 7, in which the preparation for chroma keying comprises masking one or more areas of one of the broadcast signals so that the masked area is not displayed after said chroma keying.

9. A method according to claim 7, further comprising the step of processing one of said received broadcast signals according to instructions in the broadcast signal to prepare the signal for chroma keying.

10. A set-top-box including the broadcast enhancement system of claim 1.

11. A set-top-box adapted to apply to a received television broadcast the method of claim 7.
